(19) United States
(12) Patent Application Publication
(10) Pub. No.: US 2007/0131463 A1
(43) Pub. Date: Jun. 14, 2007

(54) Wheelchair

(76) Inventor: Min-Sook Kim, Seoul (KR)

Correspondence Address: LADAS & PARRY LLP, 224 SOUTH MICHIGAN AVENUE, SUITE 1600, CHICAGO, IL, 60604, US

(21) Appl. No.: 11/636,775

(22) Filed: Dec. 11, 2006

(30) Foreign Application Priority Data
Dec. 9, 2005 (KR) KR20-2005-0034749

(51) Int. Cl. B60K 1/00

(52) U.S. Cl. 180/65.1

(57) ABSTRACT

Provided is a wheelchair. The wheelchair includes: a car body in which a gear box is equipped and a receiving portion is formed; a sheet equipped on top of the car body; driving wheels respectively equipped in both sides of the central portion of the car body; a pair of front wheels equipped in the front side of the car body; a pair of rear wheels which are equipped in the rear bottom of the car body so that when the rear side of the car body is slanted, the rear side of the car body is supported on the ground floor; a driving unit which drives the driving wheels; and a steering device which is equipped in the front side of the car body and controls the front wheels to the left and right. The steering handle is turned and thus the driving wheels are driven by the driving unit so that the wheelchair can be driven. Moreover, auxiliary wheels are further equipped in either side of the car body. Accordingly, an accident of overturning the wheelchair due to an obstacle including a small-sized stone etc., at the time of running of the wheelchair, can be prevented. Moreover, the rear wheels are provided at the rear side of the car body, an accident that the wheelchair is completely overturned can be prevented when the wheelchair goes up an inclined way. Accordingly, the wheelchair can run more safely. Moreover, the front cover and the rainwear cover are further equipped to protect a passenger with the front cover and the rainwear cover spread at the front and rear sides of the car body. Accordingly, a passenger can run the wheelchair without being exposed to the rain for the rainy day.

### CROSS-REFERENCE TO RELATED PATENT APPLICATION

This application claims the benefit of Korean Utility Model Registration Application No. 20-2005-0034749, filed on Dec. 9, 2005, in the Korean Intellectual Property Office, the disclosure of which is incorporated herein in its entirety by reference.

### BACKGROUND OF THE INVENTION

1. Field of the Invention

The present invention relates to a wheelchair, and more particularly, to a wheelchair in which driving of the wheelchair is facilitated.

2. Description of the Related Art

In general, wheelchairs are used when a patient or the old or weak who feels it uncomfortable to move moves. The wheelchair includes a chair portion which is used for seating the hip of a person, and rear wheels and front wheels which are provided in either side of the chair portion, in which hand rims are equipped in the rear wheels respectively.

In the case of the conventional wheelchair, a passenger turns the hand rims equipped in the rear wheels by the hands, in order to make the wheelchair move to a desired place.

Accordingly, since the hand rims equipped in the rear wheels should be turned directly by the hands in the case of the conventional wheelchair, a large amount of force is needed at the time of driving the wheelchair. It is also inconvenient to directly turn the rear wheels by the hands.

It is also impossible for a passenger boarding in a wheelchair to climb an inclined way without any help of the other person.

Moreover, if one of the rear wheels hangs on an obstacle including a small-sized stone etc., at the time of running of the wheelchair, an accident of overturning the wheelchair may happen since the rear wheel is lifted upwards. The danger of a safety accident may be caused during running of the wheelchair, in which case the passenger boarding in the wheelchair may be wounded.

In order to solve the above problems, an electric-powered wheelchair using an electric motor has been developed and used. However, there is a problem that the cost of manufacturing the electric-powered wheelchair is expensive.

In addition to the expensive manufacturing cost, a sale price rises up. Accordingly, it is difficult for an ordinary people to purchase and use the electric-powered wheelchair.

### SUMMARY OF THE INVENTION

To solve the above problems of the conventional art, it is an object of the present invention to provide a wheelchair in which driving of the wheelchair is facilitated even in an inclined way, redirection of the wheelchair is facilitated, and running of the wheelchair is more safely accomplished.

To accomplish the above object of the present invention, there is provided a wheelchair comprising: a car body in which a gear box is equipped and a receiving portion is formed; a sheet equipped on top of the car body; driving wheels respectively equipped in both sides of the central portion of the car body; a pair of front wheels equipped in the front side of the car body; rear wheels which are equipped in the rear bottom of the car body so that when the rear side of the car body is slanted, the rear side of the car body is supported on the ground floor; a driving unit which drives the driving wheels; and a steering device which is equipped in the front side of the car body and controls the front wheels to the left and right.

Preferably the driving unit comprises: a steering handle in which a steering handle shaft is penetrated and set up in the front side of the gear box, a steering handle body is combined in the upper portion of the steering handle shaft, and a steering handle grip is protrudingly formed in one side of the steering handle body; a worm combined in the lower portion of the steering handle shaft; a power transmission shaft whose both ends are supported in both sides of the inner portion of the gear box; a worm gear which is combined on the power transmission shaft and is tooth-engaged with the worm; a pair of large chain sprockets which are combined on the power transmission shaft at both sides of the worm gear, and are rotated with the power transmission shaft according to rotation of the worm gear; a driving shaft which is installed on the bottom of the car body and with both ends of which the driving wheels are combined; a pair of small chain sprockets which are combined with the driving shaft in one side of the driving wheels; and a pair of chains which are engaged with the large chain sprockets and the small chain sprockets, respectively.

Preferably, the steering device comprises: a footstool on the bottom of which the pair of front wheels are installed in combination, and which is hinge-coupled in the front of the car body to then move to the left and right around the hinge coupled portion; and a steering lever at the central portion of which a coupling pipe portion combined in the upper portion of the gear box is equipped, in which a steering handle portion is formed in one end extended from one side of the coupling pipe portion, and the other end which is extended from the other side of the coupling pipe portion is combined with and fixed to one side of the footstool.

Preferably, the wheelchair further comprises auxiliary wheels which are located in either side of the driving wheels and are installed in both sides of the car body so as to be folded.

Preferably, the wheelchair further comprises a front cover which is combined in the upper portion of the footstool and is folded to the top and bottom around the central portion thereof.

Preferably, the wheelchair further comprises a rainwear cover which is equipped in the rear side of the car body, and whose lower portion is coupled with the upper-center portion of the car body, in which the rainwear cover is folded to form an arc back and forth around the coupled portion.

Therefore, without experiencing a discomfort which is caused by directly turning driving wheels of a wheelchair by the hands, the driving wheels of the wheelchair are driven by manually turning a steering handle so as to make the wheelchair driven to move.

When a passenger boarding in a wheelchair climbs up a tilt way, he or she can safely climb up the tilt way by manually turning only a steering handle without having any help of the other person and without having a phenomenon that the wheelchair is pushed back.

In addition, an accident of a wheelchair overturning to the lateral or rear side can be prevented, to thereby enable a safer driving of the wheelchair.

Since a front cover and a rainwear cover are further included to escape from the rainfall, it is possible to drive a wheelchair even at the rainy times.

Since a driving unit which enables a wheelchair to climb up an inclined way without having an electric motor is equipped in the wheelchair, a wheelchair manufacturing cost is reduced. Thus, any persons who need wheelchairs can purchase and drive a wheelchair at a considerably low cost.

### BRIEF DESCRIPTION OF THE DRAWINGS

The above and other objects and advantages of the present invention will become more apparent by describing the preferred embodiment thereof in more detail with reference to the accompanying drawings in which:

FIG. 1 is a side view illustrating a configuration of a wheelchair according to an embodiment of the present invention;

FIG. 2 is a schematic front view showing a drive unit for a wheelchair according to the embodiment of the present invention;

FIG. 3 is a schematic sectional view showing an installation structure of an auxiliary wheel according to the embodiment of the present invention; and

FIG. 4 is schematic side view illustrating the state where the wheelchair is covered with a rainwear cover according to the present invention.

### DETAILED DESCRIPTION OF THE INVENTION

A wheelchair according to a preferred embodiment of the present invention will be described with reference to the accompanying drawings.

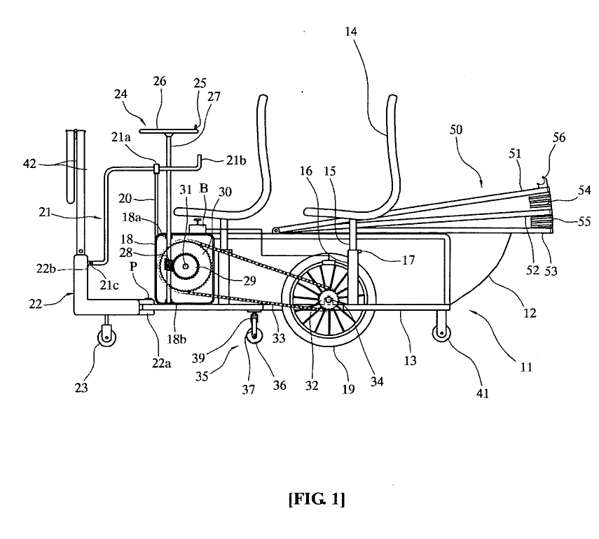

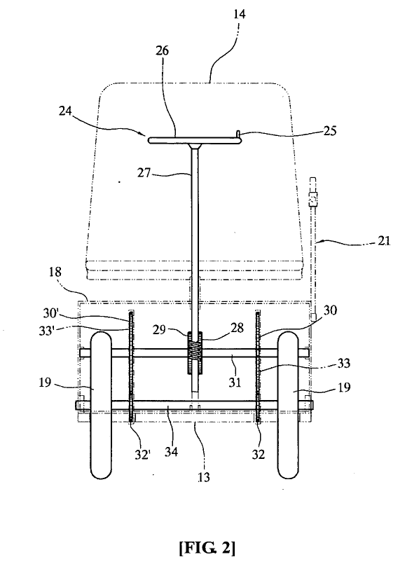

FIG. 1 is a side view illustrating a configuration of a wheelchair according to an embodiment of the present invention and FIG. 2 is a schematic front view showing a drive unit for a wheelchair according to the embodiment of the present invention.

The wheelchair according to the exemplary embodiment of the present invention includes a receiving portion 12 which is formed at the rear end of a car body 11, a gear box 18 which is equipped at the front side of the car body 11, and a pair of seats 14 which are formed on top of the car body 11.

Here, the seats 14 are installed in a structure where the saddle of an ordinary bicycle is installed. A seat coupling pipe 16 in which a spring (not shown) is built is installed on the floor 13 of the car body 11 in correspondence to each seat 14. A seat post 15 equipped on the bottom surface of each seat 14 is combined with the seat coupling pipe 16.

A seat fastener 17 controlling the height of the seat 14 and fixing the seat 14 at the height-controlled state is provided at one side of the seat coupling pipe 16.

Moreover, driving wheels 19 are equipped in both sides of the central portion of the car body 11, and a pair of front wheels 23 which are connected with a steering device to be described later is provided at the front side of the car body 11. A pair of rear wheels 41 are provided on the rear-bottom of the car body 11 in which the rear side of the car body 11 is supported on the ground when the rear side of the car body 11 is slanted.

A braking device B is fixed at the upper surface of the gear box 18 and is used to reduce the speed of the driving wheels 19 or make the driving wheels 19 stop.

A steering device is provided at the front side of the car body 11 to control the pair of front wheels 23 to the left and right. A driving unit which drives the driving wheels 19 is provided in the car body 11. As shown in FIGS. 1 and 2, the driving unit includes a steering handle 24, a worm 28 and a worm gear 29, a power transmission shaft 31, a driving shaft 34, a pair of large chain sprockets 30 and 30′, a pair of small chain sprockets 32 and 32′, and a pair of chains 33 and 33′.

A steering handle shaft 27 of the steering handle 24 is penetrated into the front side of the gear box 18 and are jointed with coupling units 18a and 18b which are protruded in a tubular form on the bottom surface and the top surface in the gear box 18. A steering handle grip 25 is protruded in one side of a steering handle body 26 combined with the upper portion of the steering handle shaft 27.

The worm 28 is combined in the lower portion of the steering handle shaft 27, and the power transmission shaft 31 is provided in the gear box 18 in which both ends of the power transmission shaft 31 are supported in either side of the gear box 18.

The worm gear 29 which is tooth-engaged with the worm 28 is combined at the center of the power transmission shaft 31. A pair of large chain sprockets 30 and 30′ which are rotated with the power transmission shaft 31 according to rotation of the worm gear 29 are combined on the power transmission shaft 31 at both sides of the worm gear 29.

A driving shaft 34 with both ends of which the driving wheels 19 are combined is installed on the bottom of the car body 11. A pair of small chain sprockets 32 and 32′ which are combined with the driving shaft 34 are provided in one side of the driving wheels 19.

Moreover, a pair of chains 33 and 33′ are engaged with the large chain sprockets 30 and 30′ and the small chain sprockets 32 and 32′, respectively.

Meanwhile, the steering device includes a footstool 22 and a steering lever 21 in order to control the pair of front wheels 23 to the left and right and control an advancing direction when the wheelchair 10 advances.

The pair of front wheels 23 are installed in combination on the bottom of the footstool 22. A first hinge portion 22a is hinge-coupled in the front-bottom of the car body 11 by a hinge pin P. Accordingly, the footstool 22 can be rotated to the left and right around the hinge pin P.

A coupling pipe portion 21a combined in a coupling shaft 20 which is protruded in one side of the gear box 18 is equipped at the central portion of the steering lever 21. A steering handle portion 21b is formed in one endextended from one side of a coupling pipe portion 21a, and a coupling rib 21c is formed in the other end which is extended from the other side of the coupling pipe portion 21a. The coupling rib 21c is combined with and fixed to one side of the footstool 22, that is, a second hinge portion 22b.

In addition, the wheelchair according to the embodiment of the present invention further includes auxiliary wheels 35 which are located in either side of the driving wheels 19 and are installed in both sides of the car body 11 so as to be folded. Each auxiliary wheel 35 includes a wheel 36 and a fixing bar 37 which fixes the wheel 36, and is installed in a coupling bracket 39 which is provided on the bottom of the car body 11 so as to be folded.

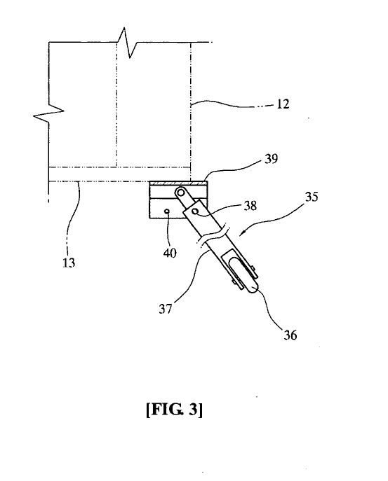

Here, as shown in FIG. 3, ball type elastic projections 38 each whose inner portions plays a role of an elastic function by a built-in spring (not shown) are provided at both sides of the fixing bar 37. Coupling grooves 40 are mutually symmetrically formed on both side surfaces of the inner-lower portion of the coupling bracket 39.

The upper portion of the fixing bar 37 in the auxiliary wheel 35 is pin-coupled with the inner-upper portion of the coupling bracket 39 by a pin. The elastic projections 38 positioned at both sides of the fixing bar 37 are coupled with the coupling grooves 40 formed in the inner side of the corresponding coupling bracket 39.

Meanwhile, the wheelchair according to the embodiment of the present invention further includes a front cover 42 which is combined in the upper portion of the footstool 22 and is folded to the top and bottom around the central portion thereof.

Furthermore, the wheelchair according to the embodiment of the present invention further includes a rainwear cover 50 which is equipped in the rear side of the car body 11, and whose lower portion is coupled with the upper-center portion of the car body 11, in which the rainwear cover 50 is folded to form an arc back and forth around the coupled portion.

The rainwear cover 50 has a generally U-shaped hood, and includes a first rib 51, a second rib 52, and a third rib 53. The leading ends of the first rib 51, the second rib 52, and the third rib 53 are combined in either side of the upper-central portion of the car body 11.

Moreover, the third rib 53 is equipped at the fixed state in the rear side of the car body 11. In addition, the first rib 51 and the second rib 52 are provided to rotate back and forth around both sides of the car body 11 where the leading ends of the first rib 51 and the second rib 52 are coupled. Transparent waterproof cloths 55 are adhered to the first rib 51, the second rib 52, and the third rib 53.

Moreover, a plurality of auxiliary ribs 54 are attached to and fixed in the inner surface of the waterproof cloths 55 between the first rib 51 and the second rib 52, and between the second rib 52 and the third rib 53. A fixing piece 56 which fixes the rainwear cover 50 on a front cover 42 is formed at the center of the first rib 51, when spreading the rainwear cover 50.

If a patient takes a seat on the seat 14 in the wheelchair according to the exemplary embodiment of the present invention, in order to move, the feet of the passenger is positioned on the footstool 22 formed in the front of the car body 11. Then, the passenger operates the driving unit to let the wheelchair 10 move forward.

That is, if the passenger takes the hold of the steering handle grip 25 of a steering handle body 26 by the hand and turns the steering handle clockwise, a steering handle shaft 27 is rotated and a worm 28 combined with the steering handle shaft 27 is rotated.

If the worm 28 is rotated, a worm gear 29 tooth-engaged with the worm 28 is rotated. If the worm gear 29 is rotated, the power transmission shaft 31 with which the worm gear 29 is combined is rotated. Accordingly, the large chain sprockets 30 and 30′ positioned at either side of the worm gear 29 are rotated.

Meanwhile, if the large chain sprockets 30 and 30′ are rotated, the chains 33 and 33′ are transferred along the rotational direction of the large chain sprockets 30 and 30′. Accordingly, the small chain sprockets 32 and 32′ are rotated together with the chains 33 and 33′.

As a result, the driving wheels 19 at both sides of the wheelchair 10 are rotated so that the wheelchair 10 is advanced.

If the wheelchair 10 is advanced as described above, a steering device is controlled in order to control the advancing direction of the wheelchair 10. If a passenger makes the footstool 22 rotated to the left or right side using the feet, the wheelchair 10 can be moved forward to the left or right direction.

If a passenger cannot use his or her feet, he or she manipulates a steering lever 21 to thus control the advancing direction of the wheelchair 10. Here, if the passenger takes the hold of the steering handle grip 21b of the steering lever 21 and then makes the steering lever 21 move to the left or right sides, the steering lever 21 is moved to the left or right side around the coupling shaft 20 and simultaneously the footstool 22 can be moved to the left or right side since the coupling pipe portion 21a is coupled with the upper portion coupling shaft 20 of the gear box 18.

Moreover, in the case that the auxiliary wheels 35 are spread outwards at the time of advancement of the wheelchair 10, an accident that the wheelchair 10 is tilted to thus cause an overturn can be prevented. The spread auxiliary wheels 35 are folded inwards at the time of passage of an alley. Accordingly, the auxiliary wheels 35 do not interfere the wheelchair 10 from passage of an alley.

Here, the auxiliary wheels 35 can be folded by the hand at the state where a passenger is on board and droops his or her upper body. When the auxiliary wheels 35 are folded, the elastic projections 38 equipped in both sides of the fixing bar 37 are elastically supported by and separated from the corresponding coupling grooves 40 in the inner side of the coupling bracket 39. Accordingly, the auxiliary wheels 35 are conveniently folded.

In the meantime, when the wheelchair 10 climbs up an inclined way, the steering handle 24 is turned so that the wheelchair 10 advances forward as described above. While the rear wheels 41 equipped in the rear bottom surface of the car body 11 are supported on the ground, to thereby support the rear side of the wheelchair 10 safely.

Here, the wheelchair 10 does not move backward when the wheelchair 10 climbs up an inclined way.

That is, since the worm 28 and the worm gear 29 of the driving unit have the feature that they do not counter-rotate, the driving unit which drives the wheelchair 10 does not counter-rotate. As a result, the wheelchair 10 is not reversed at all from an inclined way.

Accordingly, when the wheelchair 10 goes up an inclined way, it can climbs up the inclined way without running a risk that the wheelchair 10 goes down. In addition, the wheelchair 10 can travel up an inclined way without having any help from the other person.

Moreover, the folded front cover 42 is spread and erected, in which the front cover 42 is installed at the front of the car body 11. Here, the front cover 42 is spread up to the eye level of a passenger to thus cover the front side of the passenger.

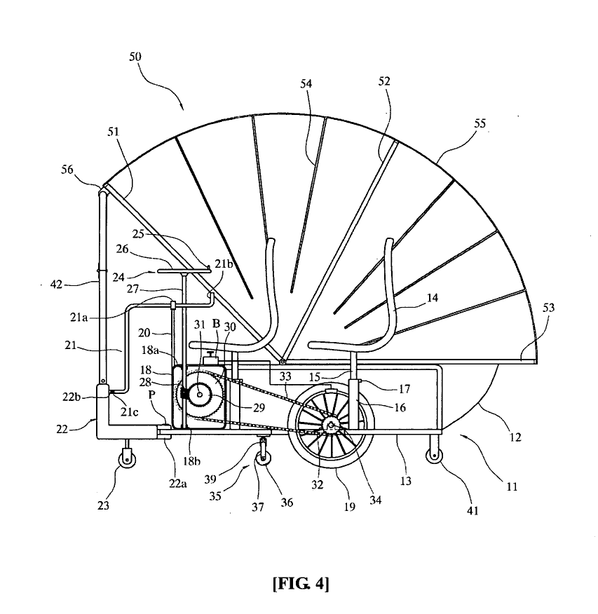

Then, a rainwear cover 50 of a folded state at the rear side of the car body 11 is spread. If a passenger takes the hold of the rainwear cover 50 and spreads it to the front side, the first rib 51 and the second rib 52 are rotated and unfolded to the front side. Here, the rainwear cover 50 forms an arc and unfolded as shown in FIG. 4.

In this way, the rainwear cover 50 is unfolded to thus combine the fixing piece 56 formed at the central portion of the first rib 51 with the upper portion of the front cover 42. Accordingly, the unfolded rainwear cover 50 is fixed.

As a result, the front cover 42 and the rainwear cover 50 protect the front side and the upper portion of a passenger from being exposed to the rain. Thus, the passenger can run the wheelchair 10 freely from the rain.

In the case of the wheelchair 10 according to the present invention, the steering handle 24 is turned using the worm 28 and the worm gear 29 which do not counter-rotate. Accordingly, the driving wheels 19 are driven to thus make the wheelchair 10 advance forward. Moreover, when the wheelchair 10 goes up an inclined way, it is not pushed behind but climbs up the inclined way.

Moreover, an electric motor is used to drive the conventional power-driven wheelchair in order to safely go up an inclined way. However, any electric motor is not used in the wheelchair according to the present invention, but a driving unit which enables the wheelchair to climbs up an inclined way manually is provided in the present invention. As a result, the manufacturing cost for the wheelchair according to the present invention becomes more inexpensive than the conventional power-driven wheelchair.

Accordingly, in the case of the wheelchair according to the present invention, the steering handle 24 is turned and thus the driving wheels 19 are driven by the driving unit so that the wheelchair 10 can be driven. Therefore, the present invention can solve the demerit of the conventional wheelchair in which a passenger directly should turn the wheels by the hand to let the wheelchair move forward.

Moreover, in the case of the wheelchair according to the present invention, the advancing direction of the wheelchair 10 can be controlled by the hands and feet using the footstool 22 and the steering lever 21. Therefore, the present invention can solve the inconveniences that a driving wheel of one side of the conventional wheelchair should be turned by the hand in order to make the wheelchair advanced to the left or right direction, and thus to select the advancing direction of the wheelchair.

Moreover, in the case of the wheelchair according to the present invention, the auxiliary wheels 35 are further equipped in either side of the car body 11. Accordingly, an accident of overturning the wheelchair due to an obstacle including a small-sized stone etc., at the time of running of the wheelchair, can be prevented. Moreover, the rear wheels 41 are provided at the rear side of the car body 11, in the present invention, an accident that the wheelchair 50 is completely overturned can be prevented when the wheelchair 50 goes up an inclined way. Accordingly, the wheelchair 10 can run more safely.

Moreover, in the case of the wheelchair according to the present invention, the front cover 42 and the rainwear cover 50 are further equipped to protect a passenger with the front cover 42 and the rainwear cover 50 spread at the front and rear sides of the car body 11. Accordingly, a passenger can run the wheelchair 10 without being exposed to the rain for the rainy day.

In the meantime, the driving unit equipped in the wheelchair according to the present invention can be installed as a driving unit for a bicycle.

Therefore, without experiencing a discomfort which is caused by directly turning driving wheels 19 of a wheelchair 10 by the hands, the driving wheels 19 of the wheelchair 10 are driven by manually turning a steering handle 24 so as to make the wheelchair 10 driven to move.

When a passenger boarding in a wheelchair 10 climbs up a tilt way, he or she can safely climb up the tilt way by manually turning only a steering handle 24 without having any help of the other person and without having a phenomenon that the wheelchair 10 is pushed back.

In addition, an accident of a wheelchair 10 overturning to the lateral or rear side can be prevented, to thereby enable a safer driving of the wheelchair 10.

Since a front cover 42 and a rainwear cover 50 are further included to escape from the rainfall, it is possible to drive a wheelchair 10 even at the rainy times.

Since a driving unit which enables a wheelchair 10 to climb up an inclined way without having an electric motor is equipped in the wheelchair, a wheelchair manufacturing cost is reduced. Thus, any persons who need wheelchairs 10 can purchase and drive a wheelchair 10 at a considerably low cost.

As described above, the present invention has been described with respect to particularly preferred embodiments. However, the present invention is not limited to the above embodiments, and it is possible for one who has an ordinary skill in the art to make various modifications and variations, without departing off the spirit of the present invention.

What is claimed is:

1. A wheelchair comprising:
a car body in which a gear box is equipped and a receiving portion is formed;
a sheet equipped on top of the car body;
driving wheels respectively equipped in both sides of the central portion of the car body;
a pair of front wheels equipped in the front side of the car body;
a pair of rear wheels which are equipped in the rear bottom of the car body so that when the rear side of the car body is slanted, the rear side of the car body is supported on the ground floor;
a driving unit which drives the driving wheels; and
a steering device which is equipped in the front side of the car body and controls the front wheels to the left and right.

2. The wheelchair according to claim 1, wherein the driving unit comprises:
a steering handle in which a steering handle shaft is penetrated and set up in the front side of the gear box, a steering handle body is combined in the upper portion of the steering handle shaft, and a steering handle grip is protrudingly formed in one side of the steering handle body;
a worm combined in the lower portion of the steering handle shaft;
a power transmission shaft whose both ends are supported in both sides of the inner portion of the gear box;
a worm gear which is combined on the power transmission shaft and is tooth-engaged with the worm;
a pair of large chain sprockets which are combined on the power transmission shaft at both sides of the worm gear, and are rotated with the power transmission shaft according to rotation of the worm gear;
a driving shaft which is installed on the bottom of the car body and with both ends of which the driving wheels are combined;
a pair of small chain sprockets which are combined with the driving shaft in one side of the driving wheels; and
a pair of chains which are engaged with the large chain sprockets and the small chain sprockets, respectively.

3. The wheelchair according to claim 1, wherein the steering device comprises:
a footstool on the bottom of which the pair of front wheels are installed in combination, and which is hinge-coupled in the front of the car body to then move to the left and right around the hinge coupled portion; and
a steering lever at the central portion of which a coupling pipe portion combined in the upper portion of the gear box is equipped, in which a steering handle portion is formed in one end extended from one side of the coupling pipe portion, and the other end which is extended from the other side of the coupling pipe portion is combined with and fixed to one side of the footstool.

4. The wheelchair according to claim 1, further comprising auxiliary wheels which are located in either side of the driving wheels and are installed in both sides of the car body so as to be folded.

5. The wheelchair according to claim 1, further comprising a front cover which is combined in the upper portion of the footstool and is folded to the top and bottom around the central portion thereof.

6. The wheelchair according to claim 1, further comprising a rainwear cover which is equipped in the rear side of the car body, and whose lower portion is coupled with the upper-center portion of the car body, in which the rainwear cover is folded to form an arc back and forth around the coupled portion.
